(19) United States
(12) Patent Application Publication
(10) Pub. No.: US 2024/0328901 A1
(43) Pub. Date: Oct. 3, 2024

(54) Method for determining a compensated acceleration gradient for a motor vehicle tire, method for monitoring motor vehicle tire wear, and motor vehicle for implementing said methods

(71) Applicant: Continental Automotive Technologies GmbH, Hannover (DE)

(72) Inventors: Nicolas GUINART, Toulouse (FR); Jean-Philippe BOISSET, Montauban (FR)

(21) Appl. No.: 18/615,027

(22) Filed: Mar. 25, 2024

(30) Foreign Application Priority Data
Mar. 28, 2023 (FR) 2302952

(51) Int. Cl. G01M 17/02; B60C 11/24; B60C 19/00

(52) U.S. Cl. CPC G01M 17/02; B60C 11/246; B60C 2019/004

(57) ABSTRACT

A method for determining a compensated acceleration gradient for a tire of a vehicle including sensors for acquiring signals indicative of variables considered from a group including: the tire pressure of the tire, the footprint quotient and the speed of the vehicle, the compensated acceleration gradient being a function of a raw acceleration gradient, of instantaneous values and of reference values of the variables. The compensated acceleration gradient is a function of compensation factors obtained by a learning phase of acquiring the values for the raw acceleration gradient and of calculating the compensation factors. A tire wear monitoring method and to a motor vehicle for implementing the methods are also disclosed.

### CROSS REFERENCE TO RELATED APPLICATIONS

This application claims priority to French Patent Application No. 2302952, filed Mar. 28, 2023, the contents of such application being incorporated by reference herein.

### FIELD OF THE INVENTION

The present invention relates to a method for determining a compensated acceleration gradient for a motor vehicle tire, to a method for monitoring motor vehicle tire wear, and to a motor vehicle for implementing said methods.

### BACKGROUND

Conventionally, a tire comprises on its outer surface a zone referred to as the “tread”, corresponding to the outer surface of the tire that is in contact with the roadway.

The tread comprises a relief, also called the “tread pattern”, making it possible in particular to remove rainwater, snow, dust, heat, etc., in order to limit loss of grip of the tire or prevent aquaplaning.

Over the course of the kilometers traveled by the vehicle, the tread of the tire wears and becomes smooth, which increases the risk of loss of grip. Beyond a certain level of wear, it is thus necessary to replace the worn tire with a new tire.

In order to detect the wear of a tire, it is known practice to use methods for monitoring the state of wear of the tire.

A first type of method, referred to as “direct methods”, makes it possible to deduce the deterioration of the tire through the use of a device that wears at the same time as the tire.

These methods can be manual, by means of a colored wear strip incorporated into the tread. This solution is however somewhat unsatisfactory in that the owner of the vehicle must visually inspect their tire in order to determine whether it should be replaced. They must also remember to inspect their tires themselves. A person with average attention does not systematically inspect their tires and after a certain amount of time, there is a risk that they will travel in a vehicle fitted with worn tires with only little grip, which poses an obvious hazard.

There is also a growing need for autonomous monitoring of the wear of a tire, in particular in the context of vehicle fleet management, which model forms part of the growing development of new modes of mobility in which the driver is not the owner and in which tracking and maintenance are carried out by specific organizations on large groups of vehicles. Autonomous monitoring of the wear of a tire also applies to an even greater extent to autonomous vehicles.

The autonomous methods for monitoring tire wear also include direct methods that make it possible to deduce the deterioration of the tire and are implemented in particular by measuring variations in impedance of tubes that pass through the tire.

A second type of method, referred to as “indirect methods”, makes it possible to deduce a state of wear of the tire by using data originating from one or more parameters of the wheel or of the motor vehicle.

The indirect methods for automatic monitoring of tire wear include a method known as tread depth monitoring, or TDM.

This method mainly uses signals originating from systems on board the motor vehicle to deduce a state of wear of the tires.

These onboard systems comprise in particular:
a global positioning system, or GPS, which makes it possible to acquire the speed of the motor vehicle,
a wheel speed sensor, or WSS, which makes it possible to acquire the rotational speed of the wheels of the motor vehicle,
a tire pressure monitoring system, or TPMS module, which makes it possible to acquire the tire pressure.

The indirect methods for automatic monitoring of tire wear also include a method known as tread depth sensing, or TDS, which aims to more directly use a signal that is perceived by the TPMS module and in which the state of wear of the tires is almost exclusively taken from this signal.

Unlike the aforementioned TDM method, in which a set of information acquired by different sensors of the motor vehicle is compiled, the TDS method is applied as close as possible to the source of the parameter to be monitored, which makes it possible to reduce the cause and effect chain used to deduce a state of wear of the tires of the motor vehicle. Using the TDS method, the cause and effect chain is thus much shorter and thus more precise than the chain obtained using the TDM method.

One TDS method known from the prior art consists in using the acceleration signal in the contact patch, in which the tire is in contact with the ground, to deduce a state of wear of the tire therefrom. This signal, also referred to as the “acceleration gradient in the contact patch”, corresponds to the acceleration signal perceived by the TPMS module that is mounted in the tire and attached on the tread of the tire. The accelerometer of the TPMS module monitors the acceleration gradient during rotation of the wheel on which the tire to be monitored is mounted.

The value of the acceleration gradient, and the interpretation made of it, indicates the state of wear of the tire that is being monitored.

However, other parameters that are dependent on the context in which the vehicle is being used have an influence on the value of the acceleration gradient and are liable to distort the interpretation that can be made of the acceleration gradient.

Such parameters are, for example, the tire pressure, the load applied to the tire, and the tire footprint quotient FPQ.

The algorithm for calculating the acceleration gradient therefore needs to give consideration to the values of the parameters identified as being liable to influence the value of the acceleration gradient.

A solution aimed at learning these parameters beforehand, through specific preliminary tests performed at the factory and then incorporating them into the algorithm that calculates the acceleration gradient, would not be optimal.

First and foremost, such a solution would be too lengthy and expensive to implement.

Next, the compensation parameters applied in the algorithm that calculates the acceleration gradient would be applied systematically whatever the tire considered, and would be so independently of any changes that may have occurred over the course of the life of the tire.

### SUMMARY OF THE INVENTION

An aspect of the present invention seeks to overcome the disadvantages of the prior art and in order to do so relates to a method for determining a compensated acceleration gradient (Grad_{comp}) for a motor vehicle tire, the motor vehicle comprising a set of sensors able to acquire signals indicative of variables considered from a group comprising at least: the tire pressure of said tire, the footprint quotient of the wheel on which said tire is mounted, and the speed of said motor vehicle, said compensated acceleration gradient (Grad_{comp}) being a function of:
a raw acceleration gradient (Grad_{raw}),
instantaneous values (Kᵢ) of the variables considered,
reference values (Kᵢ_{_{ref}}) of the variables considered,
   said method being notable in that the compensated acceleration gradient (Grad_{comp}) is also a function of compensation factors (C_{i_comp}), specific to said variables considered and obtained by executing a learning phase whereby:
there are acquired (step E1), when said motor vehicle is in operation, and for each of said variables, sets of values of the raw acceleration gradient (Grad_{raw}) as a function of the change in said variables,
said compensation factors (C_{i_comp}) are calculated (step E2) from each of said acquired sets of values.

Thus, an aspect of the present invention makes it possible, when calculating the acceleration gradient, to take account of the changes to the behavior of the tire throughout its life in the motor vehicle.

In other words, an aspect of the present invention makes provision for the on-line acquisition, which is to say acquisition during the course of the life of the tire mounted on the vehicle in operation, of sets of values for the acceleration gradient as a function of the change in the variables identified as influencing the value of the acceleration gradient.

On the basis of these acquired sets of values, the compensation factors specific to each variable are calculated.

The compensation factors are thus updated throughout the life of the tire.

Integrating these updated compensation factors into the algorithm that calculates the compensated acceleration gradient means that it is possible to take account of the changes in behavior that occur over the course of the life of the tire, and to do so irrespective of the type of tire.

The act of measuring these parameters therefore makes it possible to compensate the acceleration gradient value and therefore refine the resulting conclusions relating to the estimated state of wear of the tire.

According to optional features of the method for determining an optimized acceleration gradient for a tire according to an aspect of the invention:
in a first embodiment, said learning phase is executed continuously;
in a second embodiment, said acquisition step (step E1) is performed over a finite period;
said learning phase is initiated following a step of detecting one or more predefined triggering events (step E11);
said triggering events are chosen from a group comprising at least: the age of said tire, the fitting/removal of said tire, the fitting/removal of the wheel comprising said tire, a predetermined distance covered by said tire, a lack of alignment of the wheel on which said tire is mounted, detection of variation of the average temperature of said tire;
the method comprises a monitoring phase (step E14) initiated when no triggering event has been detected beforehand and whereby, when said motor vehicle is in operation, over a finite period and for each of said variables, sets of values of the raw acceleration gradient (Grad_{raw}) as a function of the change in said variables are acquired;
said monitoring phase (step E12) comes after the learning phase and, for determining the compensated acceleration gradient (Grad_{comp}), use is made of the compensation factors (C_{i_comp}) acquired during said learning phase;
said step whereby the compensation factors (C_{i_comp}) are calculated from each of the acquired sets of values (step E2) is obtained by applying a multi-linear regression to each of said acquired sets of values (step E1);
said learning phase comprises, prior to the step of executing the multi-linear regression, a step of “severe” filtering which is applied to the acquired sets of values for the raw acceleration gradient (Grad_{raw});
said monitoring phase comprises a step of “un-severe” to “moderately severe” filtering which is applied to the acquired sets of values for the raw acceleration gradient (Grad_{raw}).

An aspect of the invention also relates to a method for monitoring the wear of a motor vehicle tire, comprising a step of calculating a compensated acceleration gradient for said tire, notable in that said step of calculating a compensated acceleration gradient for said tire is obtained using the method for determining a compensated acceleration gradient for a tire according to an aspect of the invention.

An aspect of the invention also relates to a motor vehicle notable in that it comprises hardware and/or software means for implementing said methods according to an aspect of the invention.

### BRIEF DESCRIPTION OF THE DRAWINGS

Other features, aims and advantages of aspects of the invention will become apparent from reading the following detailed description, for an understanding of which reference will be made to the appended drawings, in which:

FIG. 1 is a schematic view of a tire of a wheel of a motor vehicle according to an aspect of the invention.

FIG. 2 shows a curve representing the value of the radial acceleration Z of a module for monitoring the pressure of a tire to be monitored as a function of time t.

FIG. 3 shows a comparison of acceleration gradient signals from a first tire and a second tire.

FIG. 4 details the steps of a learning phase of the method for determining a compensated acceleration gradient according to an aspect of the invention.

FIG. 5 is a diagram depicting a flowchart that describes one example of an algorithm that can be employed to execute the method for determining a compensated acceleration gradient according to an aspect of the invention.

### DETAILED DESCRIPTION OF THE PREFERRED EMBODIMENTS

In the rest of the description, elements that have an identical structure or similar functions are denoted by one and the same reference.

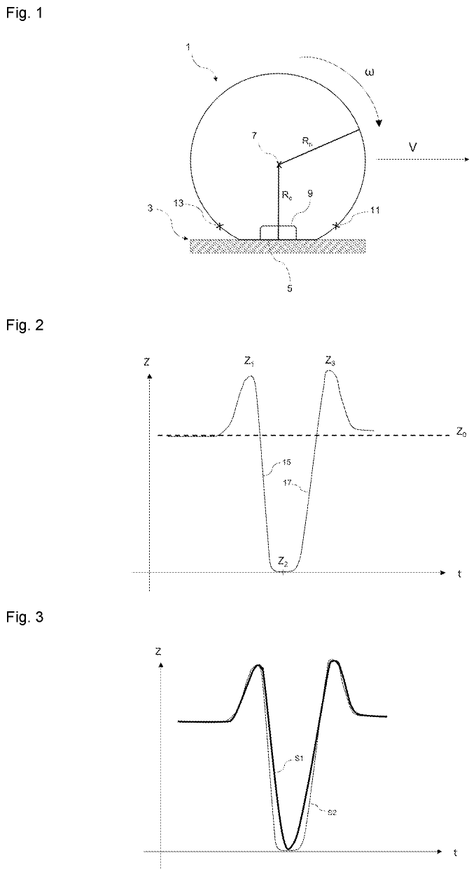

Reference is made to FIG. 1, which shows a tire 1 of a wheel of a motor vehicle according to an aspect of the invention.

The tire 1, mounted on a wheel of a motor vehicle (not shown), rests on the ground 3.

The tire 1 has a nominal radius Rn defined by the radius of the tire 1 when the wheel is unladen, that is, not mounted on the vehicle.

The laden tire 1 is deformed in the contact patch 5 in which the tire 1 is in contact with the ground 3, via its tread.

In this contact patch, the radius of the tire 1 is defined by the laden radius R_{c}, which corresponds to the distance between the axis of rotation 7 of the wheel, and the ground 3.

The tire 1 comprises a tire pressure monitoring system, or TPMS, module 9 according to an aspect of the invention, which makes it possible to acquire the tire pressure.

In the wheel position illustrated in FIG. 1, the TPMS module 9 is in contact with the ground 3.

FIG. 2 depicts the curve showing an example of the value of the radial acceleration Z perceived by the TPMS module 9 as a function of time t, for one complete rotation of the wheel on which the tire 1 is mounted.

The periodic signal representing the acceleration curve fluctuates around a static value Z₀ equal to the product of the nominal radius Rn defined by the following formula:

$${Z}_{0} = {R}_{n} \cdot {ω}^{2}$$

where:
Z₀ is a static value for the acceleration of the wheel,
Rₙ is the nominal radius of the wheel,
ω is the rotational speed of the wheel.

At the moment when the TPMS module 9 arrives almost in contact with the ground when the tire 1 is rotating in the direction of the arrow shown in FIG. 1, a pinch zone 11 (visible in FIG. 1) in which the tire 1 is pinched is generated between the tire 1 and the ground 3.

This pinch zone 11 is reflected in a local reduction in the nominal radius Rₙ of the tire 1, and in an increase in the rotational speed ω.

Given that the radial acceleration Z is equal to the product of the nominal radius Rₙ of the tire 1 and the square of the rotational speed ω, the increase in the rotational speed ω leads to an increase in the radial acceleration Z perceived by the TPMS module 9.

This increase in the radial acceleration Z perceived by the TPMS module 9 is represented in FIG. 2 by a local peak in radial acceleration Z₁ perceived by the TPMS module 9 in the pinch zone 11.

Once the TPMS module 9 has passed through the pinch zone 11 and arrived in the contact patch 5 in contact with the ground 3, the acceleration Z₂ perceived by the TPMS module 9 is zero, as the TPMS module 9 is no longer in motion.

Likewise, when the TPMS module 9 leaves the contact patch 5 in contact with the ground 3, a pinch zone 13 (visible in FIG. 1) in which the tire 1 is pinched is generated between the tire 1 and the ground 3. This pinch zone 13 is also reflected in a local reduction in the nominal radius Rₙ of the tire 1, causing an increase in the radial acceleration Z perceived by the TPMS module 9, represented in FIG. 2 by a local peak in radial acceleration Z₃ in the pinch zone 13.

The peaks in radial acceleration Z₁ or Z₃ perceived by the TPMS module 9 are reflected in a phenomenon commonly referred to as “overshoot”.

The portion 15 of the acceleration curve between Z₁ and Z₂ defines an entry acceleration gradient Grad_{entry} for entry into the contact patch 5 in contact with the ground 3 and the portion 17 of the acceleration curve between Z₂ and Z₃ defines an exit acceleration gradient Gradₑₓᵢₜ for exiting the contact patch 5 in contact with the ground 3.

The acceleration gradient in the contact patch defines a signal commonly referred to as a “footprint” signal.

Reference is made to FIG. 3, which shows a comparison between a “footprint” signal S1 of a first tire, shown in bold, and a “footprint” signal S2 of a second tire.

The entry acceleration gradient Grad_{entry} and exit acceleration gradient Gradₑₓᵢₜ for the second tire each have a steeper gradient than those obtained for the first tire, which indicates that the radius of curvature of the second tire in the pinch zones 11, 13 is smaller than that of the first tire.

The method for determining a compensated acceleration gradient according to an aspect of the invention is implemented in a motor vehicle (not depicted in the figures) equipped with hardware and software means suitable for implementing said method.

The software means comprise a computer program code means notably comprising the algorithm employed for executing the method according to an aspect of the invention.

The hardware means themselves comprise a set of sensors able to acquire signals indicative of physical variables identified as influencing the value of the acceleration gradient.

The physical variables identified as influencing the value of the acceleration gradient may be variables referred to as “instantaneous” which are directly linked to the dynamics of the movement of the motor vehicle.

The instantaneous variables have notably been identified as including:
the load applied to the wheel: specifically, when the motor vehicle is laden, the load is reacted by the tire 1, notably in the pinch zones 11, 13,
the footprint quotient: the footprint quotient is defined as the ratio between the width of the contact patch in contact with the ground and the periodicity of rotation. Thus, the footprint quotient will be higher for a tire that is more heavily laden or that has a lower inflation pressure, relative to a tire that is bearing a lower load or has a higher inflation pressure,
the inertial forces: it has been observed that the pinching of the tire 1 in its pinch zones 11, 13 increases as a function of the rotational speed of the wheel,
the pressure/temperature pair: a tire has a tendency to display pinching at the pinch zones 11, 13 that decreases as a function of its inflation pressure.

The physical variables identified as influencing the value of the acceleration gradient may also be variables referred to as “quasi-static”, these being identified notably as being:
the thickness of the tire,
the age of the tire,
the distance it has covered,
the wheel-fitting parameters: problems with the balance, alignment or parallelism of the wheels of the motor vehicle.

These variables have an impact on the way in which the tire will react in the pinch zones 11, 13 in which it is pinched against the ground.

According to an aspect of the invention, the compensated acceleration gradient is a function of:
the raw acceleration gradient at an instant t, indicative of the radial acceleration perceived by the TPMS module 9 in the vicinity of the contact patch,
instantaneous values of the variables considered,
reference values of the variables considered, and
compensation factors specific to the variables considered and updated throughout the life of the tire.

The acceleration gradient measurements acquired in the context of an aspect of the present invention are:
the entry acceleration gradient Grad_{entry}, or
the exit acceleration gradient Gradₑₓᵢₜ, or
the relative difference between the entry acceleration gradient Grad_{entry} and the exit gradient Gradₑₓᵢₜ.

The method that forms the subject of an aspect of the invention makes provision for obtaining the compensation factors by executing learning phases which are initiated throughout the life of the tire.

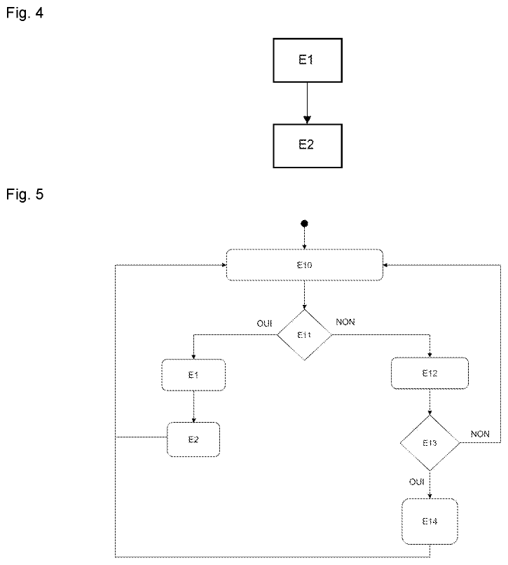

FIG. 4 details the steps of a learning phase of the method of an aspect of the invention.

The learning phase comprises a first step E1 of acquiring signals, followed by a second step E2 of calculating the compensation factors from the acquired signals.

The signal acquisition step E1 seeks to acquire, when said vehicle is in operation and for each variable identified as influencing the value of the acceleration gradient, sets of values of the raw acceleration gradient as a function of the change in these variables.

For example, when the variables being monitored are the tire pressure for the tire of the wheel, the footprint quotient and the vehicle speed, the change in acceleration gradient as a function of each of these variables is monitored.

These variables are directly accessible via the TPMS module 9. Thus, the TPMS module 9 according to an aspect of the invention comprises hardware and software means capable of implementing the method of an aspect of the invention when the variables being monitored are the tire pressure for the tire of the wheel, the footprint quotient and the vehicle speed. The software means comprise a computer program code means, notably comprising the algorithm implemented to execute the method of an aspect of the invention, while the hardware means comprise an electronic module comprising a tire pressure sensor and a radial accelerometer capable of monitoring the acceleration of the wheel.

Thus, in one example of the execution of the method according to an aspect of the invention, the TPMS module 9 is used to acquire the acceleration gradient values for each wheel of the vehicle and over a given period:
as a function of the measured pressure values,
as a function of the vehicle speed values,
as a function of the footprint quotient values.

This then yields two-dimensional or three-dimensional point clouds representing:
the values of the acceleration gradient as a function of the pressure values measured over a given period,
the values of the acceleration gradient as a function of the vehicle speed values over a given period,
the values of the acceleration gradient as a function of the footprint quotient values.

When the acceleration gradient values have been acquired, the step E2 is initiated, whereby the compensation factors specific to each variable are calculated from each of the acquired sets of values.

This calculation step is executed by means of mathematical functions notably comprising a multi-linear regression which is applied to each acquired set of values and at the end of which there is obtained a linear regression straight line indicative of the compensation factor of the variable concerned.

For reasons of memory resource limitation, the algorithm that determines the value of the compensation factor for the variable considered (step E2) is recursive, which means that the calculation is updated after each new measurement. More specifically, the step E2 is an iteration providing an intermediate update of the compensation factor considered. The step E2 is applied as many times as necessary until end-of-learning conditions are reached. The compensation-factor value from the last iteration then becomes the value adopted for calculating the compensated acceleration gradient.

The same procedure is followed for all of the tires of the vehicle and for all of the variables monitored.

The compensated acceleration gradient is then calculated using the following formula:

$${Grad}_{comp} = {Grad}_{raw} ( t ) + \sum {C}_{i \_ comp} * ( {K}_{{i}_{ref}} - {K}_{i} ( t ) )$$

where:
Grad_{comp} is the compensated acceleration gradient for the tire,
Grad_{raw}(t) is the raw acceleration gradient for the tire at an instant t,
C_{i_comp} is the compensation factor specific to the variable i considered,
Kᵢ is an instantaneous value of the variable i considered,
Kᵢ_{_{ref}} is a reference value of the variable i considered.

Thus, when the variables being monitored are the tire pressure, the footprint quotient and the vehicle speed, the compensated acceleration gradient is calculated using the following formula:

$${Grad}_{comp} = {Grad}_{raw} ( t ) + {C}_{{P}_{comp}} \cdot ( {P}_{ref} - P ( t ) ) + {C}_{FPQ \_ comp} \cdot ( {FPQ}_{ref} - FPQ ( t ) ) + {C}_{{V}_{comp}} \cdot ( {V}_{ref} - V ( t ) )$$

According to one provision of an aspect of the invention, the step of calculating the compensation factors during the learning phase may be supplemented by a filtering step that is initiated prior to the step of executing the multi-linear regression.

The type of filtering may be a filtering referred to as “severe” and is applied to the sets of acceleration gradient values acquired as a function of the variables considered, the purpose of this being to ensure that learning is conducted with input signals that are as clean as possible.

The filtering is obtained by using a statistical criterion related to the mean standard deviation of the acceleration gradient. In order to do this, a choice is made to reject an instantaneous value of the acceleration gradient where this value is an outlier outlying by a predetermined amount that is a function of this standard deviation.

For example, if the current value of the acceleration gradient is higher than the absolute value of three times the standard deviation, it is then rejected.

Thanks to the method according to an aspect of the present invention, the instantaneous variables and quasi-static variables identified as influencing the value of the acceleration gradient are compensated for in the algorithm used for calculating the acceleration gradient, so that in calculating the acceleration gradient only the tire wear need be adopted, independently of the context in which the tire is being used.

According to one execution of the method of an aspect of the invention, the acquisition step (step E1) can be executed over a finite period.

According to one provision of an aspect of the invention, the learning phase may be initiated following detection of triggering events.

By way of nonlimiting examples, the events that trigger a new learning phase are notably chosen from a group including at least:
the age of the tire: the TPMS module comprises a clock indicating that a predetermined time has elapsed, thus initiating a new learning phase,
the fitting/removal of the tire: this event may be detected by the TPMS module when the TPMS module detects that the tire pressure has become atmospheric and then been returned to a predetermined tire-inflation pressure,
the fitting/removal of a wheel: this event may be detected by means of the electronic processor of a central processing unit of the motor vehicle which detects a change in the location of a wheel in the vehicle,
a distance it has covered: the TPMS module calculates the number of kilometers covered and issues a warning when a predetermined distance covered has been reached,
a lack of parallelism of the wheel: this event may be detected by the electronic processor of the central processing unit of the motor vehicle,
detection of a variation in mean temperature: this event may for example be detected when the difference in temperature over a given period exceeds a predetermined threshold.

According to one provision of an aspect of the invention, when no triggering event has been detected, what is initiated is not a learning phase but rather a phase referred to as a monitoring phase.

According to this monitoring phase, sets of values of the raw acceleration gradient as a function of the change in said adopted variables are acquired, but the compensation factors are not calculated.

The compensation factors used for calculating the compensated acceleration gradient are therefore those acquired and stored in memory during the learning phase. The monitoring phase therefore preferably comes after the learning phase.

In the event that the monitoring phase does not come after the learning phase and the compensation factors have not yet been calculated, it is possible to use compensation factors supplied by the manufacturer for a tire type considered.

When a monitoring phase is being performed, filtering that is not as severe as that applied for the learning phase is applied to the acquired sets of values for the raw acceleration gradient. This is filtering referred to as “un-severe” to “moderately severe”. Like for the “severe” filtering, the “un-severe” to “moderately severe” filtering is applied by using a statistical criterion related to the mean standard deviation of the acceleration gradient, rejecting an instantaneous value of the acceleration gradient where this value is an outlier outlying by a predetermined amount that is a function of this standard deviation.

If the current value of the acceleration gradient is higher than the absolute value of three times the standard deviation, it is then rejected.

According to one execution variant of the method of an aspect of the invention, the acquisition step (step E1) can be executed continuously. In this embodiment, there is no longer any need for a triggering element in order to initiate the learning phase. The learning is therefore continuous, which means that there is no distinction between the learning phase and the monitoring phase. Thus, the compensation parameters are updated upon each iteration and are directly taken into consideration in calculating the compensated acceleration gradient.

Reference is made to FIG. 5 which shows a flowchart that describes one example of an algorithm that can be employed to execute the method for determining a compensated acceleration gradient for a tire of a vehicle according to an aspect of the invention.

The algorithm loops through successive iterations. The learning phase is initiated by default.

The first step of the algorithm is a step of awaiting the next iteration (step E10). When the cycle reaches a new iteration, the algorithm moves on to step E11 during which the events that may have arisen since the last iteration are evaluated. In order to do this, the algorithm poses the question of whether at least one of the triggering events listed earlier in the description has arisen.

If the response is yes, then a learning phase is initiated, during which phase all of the previously calculated compensation factors are reset, which is to say that all the compensation factors acquired beforehand are deleted.

In the learning phase, the signals indicative of physical variables identified as influencing the value of the acceleration gradient are acquired (step E1) using the dedicated sensors.

The multi-linear regression is then applied to the values of the acceleration gradient as a function of the variables considered, so as to calculate the compensation factors (step E2).

Looping back to the initial step E10, a new iteration of the algorithm is initiated using the stored previously calculated compensation factors.

The question of whether a triggering event has been detected is posed (step E11).

If the answer is no, then the previous phase, in this instance a learning phase, is continued (step E12).

The algorithm then poses the question of whether this is an end-of-learning step (step E13).

If the answer is no, it loops back to the initial step E10 and a new iteration of the algorithm is initiated.

If the answer is yes, the compensation factors are stored in memory and the method switches over to a monitoring phase (step E14).

The algorithm then loops back to the initial step E10 and a new iteration is initiated using the acquired compensation factors stored in step E14.

According to one particular application of an aspect of the invention, the calculation of the compensated acceleration gradient measured by the method that has just been described is used for implementing a method of monitoring tire wear for a tire of a motor vehicle.

It should be noted that the determination of the compensated acceleration gradient may find applications other than that of monitoring tire wear. For example, the determination of the compensated acceleration gradient may be used to detect a loss of grip of the motor vehicle, something that may arise for example in an aquaplaning situation.

Of course, aspects of the present invention are not limited solely to the embodiments of this method for determining a compensated acceleration gradient for a motor vehicle tire, of this method for monitoring the wear of a motor vehicle tire and of this motor vehicle for implementing these methods, which are described above purely by way of illustrative example, but rather it encompasses all variants involving technical equivalents of the means.

1. A method for determining a compensated acceleration gradient (Grad_{comp}) for a motor vehicle tire, the motor vehicle comprising a set of sensors able to acquire signals indicative of variables considered from a group comprising at least: the tire pressure of said tire, the footprint quotient of the wheel on which said tire is mounted, and the speed of said motor vehicle, said compensated acceleration gradient (Grad_{comp}) being a function of:
a raw acceleration gradient (Grad_{raw}),
instantaneous values (Kᵢ) of the variables considered,
reference values (Kᵢ_{_{ref}}) of the variables considered,
said method being characterized in that the compensated acceleration gradient (Grad_{comp}) is also a function of compensation factors (C_{i_comp}), specific to said variables considered and obtained by executing a learning phase whereby:
there are acquired, when said motor vehicle is in operation, and for each of said variables, sets of values of the raw acceleration gradient (Grad_{raw}) as a function of the change in said variables,
said compensation factors (C_{i_comp}) are calculated from each of said acquired sets of values.

2. The method as claimed in claim 1, wherein said learning phase is executed continuously.

3. The method as claimed in claim 1, wherein said acquisition step (step E1) is carried out over a finite period.

4. The method as claimed in claim 2, wherein said learning phase is initiated following a step of detecting one or more predefined triggering events.

5. The method as claimed in claim 4, wherein said triggering events are chosen from a group comprising at least:
the age of said tire,
the fitting/removal of said tire,
the fitting/removal of the wheel comprising said tire,
a predetermined distance covered by said tire,
a lack of alignment of the wheel on which said tire is mounted,
detection of variation of the average temperature of said tire.

6. The method as claimed in claim 4, further comprising a monitoring phase (step E14) initiated when no triggering event has been detected beforehand and whereby, when said motor vehicle is in operation, over a finite period and for each of said variables, sets of values of the raw acceleration gradient (Grad_{raw}) as a function of the change in said variables are acquired.

7. The method as claimed in claim 6, wherein said monitoring phase comes after the learning phase and in that, for determining the compensated acceleration gradient (Grad_{comp}), use is made of the compensation factors (C_{i_comp}) acquired during said learning phase.

8. The method as claimed in claim 1, wherein said step whereby the compensation factors (C_{i_comp}) are calculated from each of the acquired sets of values (step E2) is obtained by applying a multi-linear regression to each of said acquired sets of values (step E1).

9. The method as claimed in claim 8, wherein said learning phase comprises, prior to the step of executing the multi-linear regression, a step of “severe” filtering which is applied to the acquired sets of values for the raw acceleration gradient (Grad_{raw}).

10. The method as claimed in claim 6, wherein said monitoring phase comprises a step of “un-severe” to “moderately severe” filtering which is applied to the acquired sets of values for the raw acceleration gradient (Grad_{raw}).

11. A method for monitoring the wear of a motor vehicle tire, comprising a step of calculating a compensated acceleration gradient for said tire, characterized in that said step of calculating a compensated acceleration gradient for said tire is obtained using the method as claimed in claim 1.

12. A motor vehicle, comprising hardware and/or software for implementing the method as claimed in claim 1.
